(19) United States
(12) Patent Application Publication
(10) Pub. No.: US 2024/0279757 A1
(43) Pub. Date: Aug. 22, 2024

(54) DIRECT BATH SMELTING PROCESS WITH FAST QUENCH OF MOLTEN MATERIAL IN HOT OFFGAS

(71) Applicant: NUCOR CORPORATION, Charlotte, NC (US)

(72) Inventors: Rodney James Dry, City Beach (AU); Mark Hayton, Perth (AU)

(73) Assignee: NUCOR CORPORATION, Charlotte, NC (US)

(21) Appl. No.: 18/441,101

(22) Filed: Feb. 14, 2024

Related U.S. Application Data
(60) Provisional application No. 63/447,268, filed on Feb. 21, 2023.

(51) Int. Cl. C21B 13/00; C21B 13/10

(52) U.S. Cl. CPC C21B 13/0013; C21B 13/105; C21B 2100/40; C21B 2400/024; C21B 2400/032; C21B 2400/062; C21B 2400/072

(57) ABSTRACT

An improved direct smelting system and process using a smelt reduction vessel (SRV), and optionally, a cyclone converter furnace (CCF). The improved system and process utilizes a fast quench system in which hot process offgas containing molten material is quench-cooled from greater than 1400° C. (2552° F.) to no more than 600° C. (1112° F.) in a time-of-flight of no greater than 1 second. The quenching occurs using water spray injection and vaporization to cool, stress and break solid slag into slag pieces small enough to remove from the quenching system. The improved system eliminates plant availability problems associated with (i) accretion formation in the offgas train as hot process offgas cools down in a conventional (slow) manner to allow for steam-raising for power generation or other heat recovery purposes, and (ii) trigger mechanisms causing slag foaming events in the SRV that propagate up the offgas train.

### PRIORITY CLAIM UNDER 35 U.S.C. §119

The present Application for a Patent claims priority to U.S. Provisional Patent Application Ser. No. 63/447,268 entitled “Direct Bath Smelting Process with Fast Quench of Molten Material in Hot Offgas”, filed on Feb. 21, 2023, which is assigned to the assignee hereof and hereby expressly incorporated by reference herein.

### FIELD OF THE INVENTION

The present invention relates to a process and an apparatus for direct smelting a metalliferous material.

### BACKGROUND

Two known direct smelting processes for a metalliferous material, which rely principally on a molten bath as the smelting medium, are generally referred to as HIsmelt and HIsarna.

### SUMMARY OF THE INVENTION

The present disclosure is directed to an improved direct smelting process. In particular, the current disclosure is directed to reducing or eliminating plant availability problems associated with accretion formation in the offgas train of traditional HIsmelt or HIsarna processes when process offgas is cooled down in a conventional manner (e.g., slow process) for the purpose of steam-raising (e.g., produce steam of certain pressure) for use in power generation or other heat recovery purposes.

Direct smelting systems and processes utilize a smelt reduction vessel (SRV) (i.c., HIsmelt process) optionally connected to a cyclone converter furnace (CCF)(i.c., the SRV and CCF being the HIsarna process). The systems further utilize an offgas duct (otherwise described as a dogleg duct) from the SRV (or CCF if one is present) which is operated in such a manner as to maintain hot molten material on the inner surface that is in direct contact with hot process offgas within the offgas duct. This molten material is mainly molten slag which may approximate SRV slag in composition if no CCF is present (e.g., around 5% FeO, or the like), or otherwise slag containing a high percentage of melted and partly reduced iron ore if the CCF is present (e.g., around 55% FeO, or the like). The fast quenching system includes a cooling liquid nozzle system (otherwise described as a quench nozzle system or nozzle system) at the end of the offgas duct, which uses one or more nozzles (typically multiple nozzles) to spray cooling liquid (e.g., water, or other cooling liquid) to cool the hot process offgas and solidify molten material in the process offgas. Prior to the spray of liquid water, the gas temperature of the process offgas is above 1400° C., and typically 1600-2000° C. (above 2552° F., typically 2912-3632° F.). The water from the spray nozzles vaporizes rapidly and, as a result, gas temperature drops to below 600° C. (1112° F.) in an average gas particle time-of-flight of 1 second or less.

The fast quenching system may further utilize an outlet rim at the outlet of the hot offgas duct before addition of the spray of water from the nozzle system. The outlet rim, which may comprise a water-cooled smooth-surface copper ring, may aid in fracturing solid slag (otherwise described as “frozen slag”, or the like) from the wall of the offgas duct. The quench chamber, into which the water flows from the nozzle system, may be larger in diameter than the hot offgas duct itself, and the set of inwardly directed (e.g., radial inwardly extending) water sprays nozzles may be located immediately downstream of the outlet rim (e.g., the copper rim).

There are two distinct ways of configuring the quench chamber of the quench system: (1) dry-bottom and (2) wet-bottom. For the dry bottom version, the total amount of water added is just sufficient (when fully vaporized) to cool process gas to a temperature of typically 200-300° C. (392-572° F.) and no less than about 150° C. (302° F.). In this embodiment, quenched-cooled molten material, now in the form of broken solid slag pieces, is removed from a collection hopper at the base of the quench chamber in a dry state. Precise control of water injection is needed to maintain the bottom of the quench chamber above about 150° C. (302° F.). In this dry-bottom embodiment the total amount of spray water is typically about 1.0-1.5 tonnes of water per 1000 Nm³/h of hot process offgas.

For the wet-bottom embodiment, the bottom of the quench chamber is operated with either a pool or a sluice of liquid water into which frozen slag pieces (otherwise described herein as “solid slag pieces”, or “broken slag pieces”) drop. From here solid slag pieces are removed via hydraulic transport in water, either continuously or in batch mode. In the wet-bottom embodiment the total amount of water added is typically around 3-5 tonnes per 1000 Nm³/h of hot process offgas.

One embodiment of the invention is a direct smelting method for production of molten metal and slag within a direct smelting system. The direct smelting system comprises a smelt reduction vessel (SRV) containing a bath of the molten metal and the slag. Carbonaceous material is injected, and metalliferous ore is injected or fed by gravity, into the slag from above. Smelting of the metalliferous ore takes place to produce carbon-containing molten metal and molten slag, and oxygen-containing gas is injected into a topspace of the SRV to partially combust bath-derived gas and provide SRV process heat. The direct smelting system further comprising a quench system operatively coupled to the SRV. The quench system comprises a dogleg duct and a quench nozzle system operatively coupled to the dogleg duct. The direct smelting method comprises receiving process offgas in the dogleg duct from the SRV, wherein the process offgas contains entrained molten slag. The method further comprising directing the process offgas from the dogleg duct to the quench nozzle system. Rapidly cooling the process offgas using the quench nozzle system to a temperature that is less than or equal to 600° C. to form solid slag, and fracturing the solid slag into solid slag pieces for removal.

In further accord with embodiments of the invention, the direct smelting system further comprises a cyclone converter furnace (CCF) connected to the SRV. The CCF receives the process offgas from the SRV, and the metalliferous ore, a proportion of the oxygen-containing gas, and flux material are injected into the CCF. The metalliferous ore is substantially melted and partly pre-reduced before entering the SRV. Receiving the process offgas in the dogleg duct comprises receiving the process offgas from the CCF.

In other embodiments, the process offgas within the dogleg duct is maintained at a gas temperature that is greater than or equal to 1400° C. (2552° F.) before the rapid cooling by the quench nozzle system.

In still other embodiments, an average process offgas particle time-of-flight in the quench nozzle system is less than or equal to 1 second.

In yet other embodiments, the quench nozzle system injects 0.8-2.0 tonnes of water per 1000 Nm³/h of the process offgas. The final gas temperature after water vaporization is greater than or equal to 150° C. (302° F.) and less than or equal to 600° C. (1112° F.).

In other embodiments, the quench nozzle system preferably injects 1.0-1.5 tonnes of water per 1000 Nm3/h of the process offgas. The final gas temperature after water vaporization is preferably in a temperature range 200-300° C. (392-572° F.), inclusive.

In further accord with embodiments of the invention, the solid slag pieces are removed from a collection vessel at a bottom of a quench chamber in a dry state.

In other embodiments, the quench nozzle system injects 2-6 tonnes of water per 1000 Nm³/h of the process offgas, and a final gas temperature is approximately equivalent to a local water saturation temperature at prevailing process pressure.

In still other embodiments, the quench nozzle system preferably injects 3-5 tonnes of water per 1000 Nm³/h of the process offgas.

In yet other embodiments, liquid water is present at a bottom of a quench chamber and the solid slag pieces are removed from a collection vessel of the quench chamber in a wet state.

In other embodiments, the quench system further comprises an outlet rim upstream from the quench nozzle system. The outlet rim aids in fracturing the solid slag into the solid slag pieces.

Another embodiment of the invention is a direct smelting system for production of molten metal and slag. The direct smelting system comprises a smelt reduction vessel (SRV). The SRV is configured to contain a bath of the molten metal and the slag. The SRV receives carbonaceous material that is injected, and metalliferous ore that is injected or fed by gravity into the slag, from above. The metalliferous ore is smelt in the bath to produce carbon-containing molten metal and molten slag, and oxygen-containing gas injected into a topspace to partially combust bath-derived gas and provide heat to the SRV. The direct smelting system further comprises a quench system operatively coupled to the SRV. The quench system comprises a dogleg duct and a quench nozzle system operatively coupled to the dogleg duct. Process offgas from the SRV containing entrained molten slag passes through the dogleg duct to the quench nozzle system. The process offgas is rapidly cooled by the quench nozzle system to a temperature that is less than or equal to 600° C. (1112° F.) to form solid slag that fractures into solid slag pieces for removal.

In further accord with embodiments, the direct smelting system further comprises a cyclone converter furnace (CCF) connected to the SRV. The CCF receives the process offgas from the SRV, and the metalliferous ore, a portion of the oxygen-containing gas, and flux material are injected into the CCF. The metalliferous ore is substantially melted and partly pre-reduced before entering the SRV. The dogleg duct receives the process offgas from the CCF.

In other embodiments, the process offgas within the dogleg duct is maintained at a gas temperature that is greater than or equal to 1400° C. (2552° F.) before the rapid cooling by the quench nozzle system.

In still other embodiments, an average process gas particle time-of-flight in the quench nozzle system is less than or equal to 1 second.

In yet other embodiments, a majority of the cooling of the process gas in the quench system occurs through the quench nozzle system with a minority of the cooling occurring through duct cooling.

In other embodiments, the quench nozzle system injects 0.8-2.0 tonnes of water per 1000 Nm3/h of the process offgas. The final gas temperature after water vaporization is greater than or equal to 150° C. (302° F.) and less than or equal to 600° C. (1112932° F.).

In further accord with embodiments, the solid slag pieces are removed from a collection vessel at a bottom of a quench chamber in a dry state.

In other embodiments, the quench nozzle system injects 2-6 tonnes of water per 1000 Nm³/h of the process offgas. The final gas temperature is approximately equivalent to a local water saturation temperature at prevailing process pressure.

In still other embodiments, liquid water is present at a bottom of a quench chamber, and the solid slag pieces are removed from a collection vessel of the quench chamber in a wet state.

In yet other embodiments, the quench system further comprises an outlet rim upstream from the quench nozzle system. The outlet rim aids in fracturing the solid slag into solid slag pieces.

Another embodiment of the invention is a method of forming pig iron using a quench system operatively coupled to a smelt reduction vessel (SRV). The quench system comprises a dogleg duct and a quench nozzle system operatively coupled to the dogleg duct. The method comprises forming molten metal in the SRV. The method further comprises receiving process offgas in the dogleg duct from the SRV. The process offgas contains entrained molten slag. The method further comprises directing the process offgas from the dogleg duct to the quench nozzle system. Moreover, the process offgas is rapidly cooled using the quench nozzle system to a temperature that is less than or equal to 600° C. to form solid slag. The method further comprises fracturing the solid slag into solid slag pieces for removal, removing the molten metal from the SRV, and forming pig iron from the molten metal.

Another embodiment of the invention is a quench system, for use with a smelt reduction vessel (SRV), for production of molten metal and slag. The quench system comprises a dogleg duct and a quench nozzle system operatively coupled to the dogleg duct. The process offgas from the SRV contains entrained molten slag and the process offgas passes through the dogleg duct to the quench nozzle system. The process offgas is rapidly cooled by the quench nozzle system to a temperature that is less than or equal to 600° C. (1112° F.) to form solid slag that fractures into solid slag pieces for removal.

To the accomplishment of the foregoing and the related ends, the one or more embodiments of the invention comprise the features hereinafter fully described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

The present invention is described further by way of examples with reference to the accompanying drawings, of which:

FIG. 1 is a view of a direct smelting process utilizing an SRV, a CCF and a fast quench system, in accordance with embodiments of the present disclosure.

FIG. 2 is a 2D cross-sectional view of the quench nozzle system with further details regarding the configuration of the quench nozzle system, in accordance with embodiments of the present disclosure.

FIG. 3 is a 3D cross-sectional view of the quench nozzle system with further details regarding the configuration of the quench nozzle system, in accordance with embodiments of the present disclosure.

FIG. 4 illustrates a process flow for a direct smelting process with the fast quench system, in accordance with embodiments of the present disclosure.

### DETAILED DESCRIPTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements.

The term “smelting” is herein understood to mean thermo-chemical processing wherein chemical reactions that reduce metal oxides occur to produce carbon-containing molten metal. These smelting reactions take place (i) at high temperatures, (ii) only at sufficiently low oxygen potential and (iii) are highly endothermic, requiring a large heat supply to maintain constant process conditions.

Two direct smelting processes for metalliferous material which rely principally on a molten bath as the smelting medium are generally referred to as the HIsmelt process and the HIsarna process. The HIsmelt process utilizes an SRV 101, whilst the HIsarna process utilizes an SRV 101 in conjunction with a CCF 102. Although the quenching system 200 described herein relates primarily to the HIsarna process, it may also be applied to the HIsmelt process.

The HIsmelt process relates to direct smelting of metalliferous material in the form of iron and its oxides (which may be unreduced, partly reduced or highly pre-reduced) and producing molten carbon-containing iron. The process includes forming a bath of molten iron and slag in a vessel (e.g., SRV). Solid carbonaceous material (e.g., coal, or the like) is injected into the bath. Metalliferous material may be injected into the bath and/or fed into the slag layer by dropping the material from above. Solid carbonaceous material acts as a reductant of the iron oxides and a source of energy for forming the molten metal bath within the SRV.

The HIsmelt process also includes post-combusting reaction gases, such as CO and H2 released from the bath, in the generally gas-continuous space above the bath (e.g., referred to as the topspace) with oxygen-containing gas, typically hot oxygen-enriched air or technically pure cold oxygen. Heat generated by post-combustion reactions is transferred to the bath to satisfy the thermal energy required to heat and smelt the metalliferous materials.

The HIsmelt process also includes forming a transition zone above the nominal quiescent surface of the bath. In this zone, there is a mass of ascending and descending droplets and splashes or streams of molten metal and/or slag, which provides an effective medium to transfer to the bath a significant portion of the thermal energy generated by post-combusting reaction gases above the bath. This plume moves heat from the topspace where it is generated (at relatively high oxygen potential) to the bath where it is used for smelting purposes (at relatively low oxygen potential). As such, the plume effectively acts as a heat pump.

In the HIsmelt process, solid carbonaceous material and optionally metalliferous material are injected into the molten bath through a number of solids injection lances. These lances may be inclined to the vertical so as to extend downwardly and inwardly through a side wall of the vessel and into a lower region so as to deliver at least part of the solids material into a molten metal layer in the bottom of the vessel. To promote the post-combustion of reaction gases in an upper part of the vessel, cold oxygen, or a blast of hot air that may be oxygen-enriched, is injected into an upper region of the vessel through one or more downwardly extending gas injection lances. Process offgas (otherwise described as offgas) resulting from post-combustion of reaction gases in the vessel are taken away from the upper region of the vessel through an offgas duct. The vessel also includes slag-coated water-cooled panels in the side walls and the roof of the vessel, through which water is circulated in a closed cooling circuit.

Molten metal product is removed from the smelt reduction vessel (SRV) 101 via a forehearth. The forehearth is a siphon overflow device connected to the bath via an opening (“forehearth connection”) near the bottom of the metal bath in the SRV 101. The forchearth allows for extraction of molten metal from the SRV 101 in a continuous manner during operation, while maintaining a metal level in the SRV 101 that allows safe operation (c.g., keeping bulk metal well away from water-cooled elements). The molten metal may be turned into a solid product (e.g., pig iron, or the like) for use in further processing or may be used in the molten form for further processing, such as directly or indirectly used in different types of furnaces (e.g., oxygen furnaces, electric arc furnaces, or the like). As such, the product (e.g., solid or molten metal) produced from the SRV (with or without the CCF as discussed below) can be cast into a steel product (e.g., sheet, plate, bar, billet, or the like) and/or formed into an end product made from the steel product (e.g., beam, decking, structural steel, electrical steels, or the like).

The HIsarna process, as far as the SRV 101 is concerned, has the same or similar physical components and layout as the HIsmelt process, and operates in the same or similar way. A key difference between the two is that in the HIsarna process incoming metalliferous feed (typically iron ore) is not injected or dropped directly into the bath but is rather heated, partially pre-reduced, and substantially melted in a smelt cyclone converter furnace (CCF) 102 that is directly coupled to the top gas outlet of the SRV 101. Substantially molten, partly reduced iron ore droplets fall from the CCF 102 into the SRV slag, and from there final smelting proceeds. Principally, carbon-rich metal reacts with FeO in slag to produce additional carbon-containing iron metal. Carbonaceous material is still injected into the bath as previously described to carburize metal and generate the splash, fountain plume, and mixing within the SRV 101.

In both the HIsmelt and HIsarna processes, hot process offgas (either from the SRV 101 directly or from the CCF 102) is removed from the process via a steam-cooled (or water-cooled) offgas duct. In the case of HIsarna, additional oxygen may be injected into this duct in order to complete combustion of residual fuel gas (e.g., mainly CO and H2).

In traditional offgas ducts, the first part of this hot offgas duct, commonly referred to as the “dogleg”, is such that up-flowing hot process offgas from the SRV 101 or CCF 102 is forced to change flow direction twice, (i) vertical (e.g., from the SRV 101 and/or CCF 102) to near-horizontal (e.g., in the dogleg) and (ii) near-horizontal (e.g., in the dogleg) back to vertical. In this offgas duct, solid slag adhesion onto the walls is actively encouraged via mechanical means, such as provision of slag adhesion studs or similar devices. The aim of the mechanical means is to encourage formation of a frozen slag layer (otherwise described as a solid slag layer) on the walls of the duct adjacent to cooling tubes (e.g., saturated steam/water or cooling water-containing tubes) that typically surround or are formed within the outer wall of the duct. This frozen layer will grow (or re-grow) on wall surfaces cooled by the tubes to a “natural” thickness of typically 20-30 mm (0.79-1.18 inches). At this point, further solid layer growth slows because cooling (by conduction through 20-30 mm of frozen slag) is more or less balanced by heat supply from hot process offgas. A small semi-solid layer will then form on the frozen slag layer, and on top of that the slag will remain molten. In this context the actual liquid is referred to as “molten slag”, even though it may in some cases comprise predominantly melted and partly reduced iron ore.

A process objective for the dogleg is to deliberately maintain the molten slag inner surfaces. That is, liquids carried in the main offgas stream can be de-entrained by being “thrown” onto the walls and/or frozen slag attached to the walls (e.g., by virtue of residual swirl and flow direction changes within the duct, as previously described herein). This de-entrained liquid slag can then run back into the SRV under gravity, countercurrent to the outgoing hot process offgas. Gas velocity in the dogleg is insufficient (by design) to force liquid slag in the wall layer to flow in the same direction as the process offgas. Instead, liquid slag is able to run back under gravity towards and into the CCF 102 and/or SRV 101, countercurrent to the process offgas flow direction. This concept has been tested extensively and shown to work reliably.

In conventional HIsmelt and HIsarna plant designs, hot gas leaving the dogleg enters a further cooling duct in the shape of a large inverted “U”, commonly referred to as the “hood”. This comprises an upflow duct (or upleg), a large 180-degree bend at the top that usually has one or more pressure relief valves, and a downflow duct (or downleg). The legs of the hood are typically tens of meters long. Duct walls in the hood are again typically constructed from cooling tubes (e.g., steam-tubes), but in the hood, the walls are internally smooth with no mechanical means for slag adhesion (e.g., studs or similar devices). As such, solid slag is not encouraged to adhere to the walls of the hood. The process objective at the hood is to cool hot process offgas in the upleg to a temperature below that at which any liquid materials can still be present (e.g., typically 900-1000° C.; 1652-1832° F.). In one version of the hood design, sheets of slag solidify on smooth inner wall surfaces (e.g., cooled by cooling tubes, such as steam tubes) and grow in size until they become unstable and fall off (e.g., naturally due to weight, or the like). Fallen solid sheets (e.g., from the upleg, or the like) then enter the top of the dogleg where they are heated and melted (e.g., over time by the process offgas, liquid slag on the walls, or the like), then run back into the CCF 102 and/or SRV 101 as liquid. In another version of the hood design, cold gas (c.g., recycled gas, or the like) is added in an annular ring at the base of the upleg to cool the process offgas and solids more rapidly, whilst at the same time keeping molten droplets away from the walls of the upleg.

Conventional design of the hood further involves taking offgas from the hood downleg, de-dusting it in conventional dust cyclones and finally recovering heat from it in a steam boiler. Molten slag accretions are adequately managed via this strategy. Unfortunately, there is a second (lower temperature) accretion formation mechanism that causes issues with these types of slag accretion systems and complicates the process. Sticky phases comprising alkali sulphates or similar materials can form (e.g., slowly, over time) at temperatures above about 600° C. (1112° F.). These sticky materials act as a type of glue phase, and solid particles which happen to be present (e.g., as dust, or the like) can become building blocks for low-temperature accretions (e.g., with solid dust particles acting like aggregate particles in cement). This type of low temperature accretion builds and densifies over time, to the extent that, in some examples, heat transfer in the down-leg of the hood becomes seriously compromised. This type of accretion growth is thought to be largely one-directional, for example, meaning duct walls become progressively fouled over time with no “natural” self-cleaning mechanism.

An important impact of these low-temperature accretions is that they tend to build up, especially on superheater tubes in the conventional steam boiler(s). This can significantly compromise boiler performance over time. Superheater tubes have the highest metal wall temperatures in the heat recovery system (c.g., typically around 400-550° C.; 752-1022° F.) and this makes them significantly more susceptible to this type of fouling. In a practical sense, this means steam boiler availability may be compromised and, if only one such boiler is present, availability of the entire ironmaking plant will be compromised. One option to maintain the availability of the plant is to utilize two boiler systems and alternate between them, but this increases the costs of the plant and is considered a particularly expensive solution.

A second issue, unique to HIsarna, is fast foaming. This is what happens when a sufficiently large lump of iron oxide-rich solid material drops into the SRV 101. A sudden, violent reaction occurs between this lump and the carbon-containing molten metal in the bath. The result is rapid evolution of foamy slag (e.g., similar to foam in carbonated beverages) that can pass all the way down the offgas train in a few seconds. Such behavior has been documented on multiple occasions in the HIsarna pilot plant in Ijmuiden, Netherlands. The lump of solid material is thought to be triggered by iron oxide-rich solid accretions breaking off from locations, such as the hood walls (e.g., most likely at or near the base of the riser upleg). Such lumps are thought to be capable of finding their way back through the dogleg, from where they fall into the SRV 101 (via the CCF 102, when utilized) whilst retaining sufficient solids to cause the fast foaming.

Offgas boiler implications of the fast foaming are potentially dramatic. If such an event occurs, and foamy slag passes all the way through to the boiler, then the boiler itself will be almost instantly plugged with a kind of low-density slag, which may be referred to as “pumice stone” slag. Practical implications, in particular, the offline time needed to manually clean a plugged boiler in order to restart the process, are serious and costly (e.g., in particular, due to the plant downtime).

The embodiments of the present disclosure, seek to address the above identified issues by avoiding potential to (i) form low temperature accretions and (ii) form large FeO-rich lumps that can fall back into the SRV to cause fast foaming problems. The embodiments of the present disclosure are designed to remove hot gas from the SRV 101 and/or CCF 102 using an improved duct system having molten slag inner surfaces (e.g., predominately, or only molten slag inner surfaces), then utilizing a downflow configuration in which the nozzle system having water injection spray nozzles is used to “snap-freeze” hot process offgas and molten slag (e.g., at or above 1400° C.; 2552° F., or the like) to below 600° C. (1112° F.) in an average gas particle time-of-flight of less than 1 second. The use of the nozzle system substantially avoids potential for low-temperature accretion formation by stepping through the temperature window where such accretions can form in the shortest possible time. By avoiding any type of hood upleg with potential to accumulate frozen FeO-rich slag material, the potential for triggering fast foaming events in the SRV 101 is also substantially eliminated.

With this strategy of snap-freezing the process offgas, heat recovery from the process offgas may be no longer possible. In most embodiments of the HIsarna process (or HIsmelt process) stable, reliable metal production and high plant availability are more important than financial value associated with heat recovery and power generation. For example, capital cost savings (e.g., from not having a boiler) offset the operating cost penalty (e.g., connected to lack of power generation from the process offgas), leading to an essentially constant internal project rate of return. However, these calculations do not adequately capture the full impact of the plant being off-line. As such, a primary benefit of the embodiments of the present disclosure is the elimination of “cash burn” associated with potential production interruptions (e.g., caused by boiler accretion formation and/or SRV foaming).

The rapid cooling concept described herein is generally referred to as “fast quench”. Design of a suitable fast quench systems 200 requires certain special considerations. For example, the dogleg 104 of the system (e.g., with promoted slag wall adhesion and hot molten slag inner surfaces) is largely the same as in the conventional design, however, the final outlet of the dogleg 104 is directed downward. Pressure relief valves may be positioned on or close to the final part of this modified dogleg 104.

Another consideration of the fast quench system 200, is that the rim 203 of the downflowing dogleg outlet needs to be configured in such a way that molten slag at the wall, which forms a solid ring around the wall (e.g., forming a type of solid “pipe”), which will attempt to grow in a downward direction, does not stick to the walls in the final part of the downflowing dogleg duct outlet. This is because, when water sprays impact the hot “pipe” a short distance beyond the end of the dogleg outlet, the intention is to shatter quench-frozen slag into small, manageable solid slag pieces. Having the hot, molten “pipe” already loose (e.g., not adhering to the wall of the downflowing dogleg duct outlet) in the final part of its molten downward journey will help in this regard. This dogleg outlet will typically comprise a smooth, water-cooled copper rim 203 which is integral with the downward-facing end of the dogleg duct outlet. The high pressure-drop water spray nozzles (directed radially inward) of the nozzle system are positioned a short distance downstream of the outlet rim 203. Aggressive cooling takes place as water contacts the hot process offgas and slag, causing water to vaporize in significant quantities.

One or more additional secondary water spray nozzles may be positioned further downstream, depending on the total number of nozzles required and the mode of operation of the quench chamber (e.g., wet-bottom vs dry-bottom).

Further embodiments of the fast quench system 200 may require a quench chamber 108 that provides a certain gas residence-time to allow sufficient vaporization of water droplets. Precisely how much is a complex function of fluid mechanics and spray-nozzle water droplet sizes. A gas residence-time around 2-5 seconds is likely to be required, but the gas residence-time may be within, outside of, or overlap this range (e.g., below 2 seconds, or up to 6, 7, 8, 9, 10, seconds, or the like).

Additionally, in the dry-bottom embodiment, the fast quench system 200 may require precise control over how much water is injected at any given time. That is, the temperature of the gas outlet (after water vaporization) is to be maintained above about 150° C. (302° F.), so the plant control system needs to calculate real-time system thermal dynamics sufficiently well to modulate the amount injection water without creating any liquid pooling in the system. This requires a process model that is precise and detailed enough to predict (within an acceptable control margin) how much water is needed. The amount of water for dry-bottom operation is typically in the range 1.0-1.5 tonnes per 1000 Nm³/h of hot process offgas.

In the wet-bottom embodiment, excess water is deliberately injected. A liquid pool (or sluice) forms at the bottom of the quench chamber 108. Gas leaves the vessel at or close to its dew point (around 110-120° C.; 230-248° F.). An advantage of this version, under normal operating conditions, is that any surge or splutter of molten slag that escapes from the dogleg 104 and resists rapid cooling will ultimately enter a pool of water and be finally quenched there regardless. There is, however, some degree of uncertainty around plant safety in this regard. If there is a fast-foaming event in the SRV 101 (e.g., for any reason, whether or not described herein) then molten, albeit highly foamy, slag could potentially encounter a pool of liquid water. The resulting contact between liquid water and this type of highly foamy molten slag may potentially cause a steam explosion.

As such, in some embodiments the dry-bottom embodiments may be preferred. However, should the interaction of the foamy slag with the liquid water ultimately be deemed safe and/or the foamy slag creation or propagation be prevented, then the wet-bottom version of the fast quench system may likely be preferred because it is inherently easier to operate and control the water spray from the nozzle system.

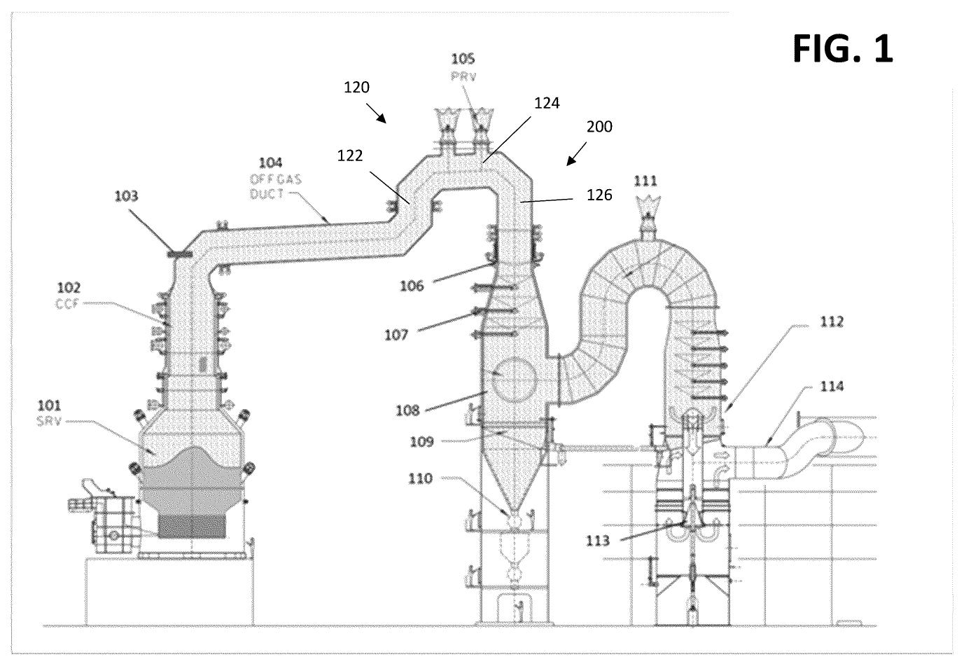

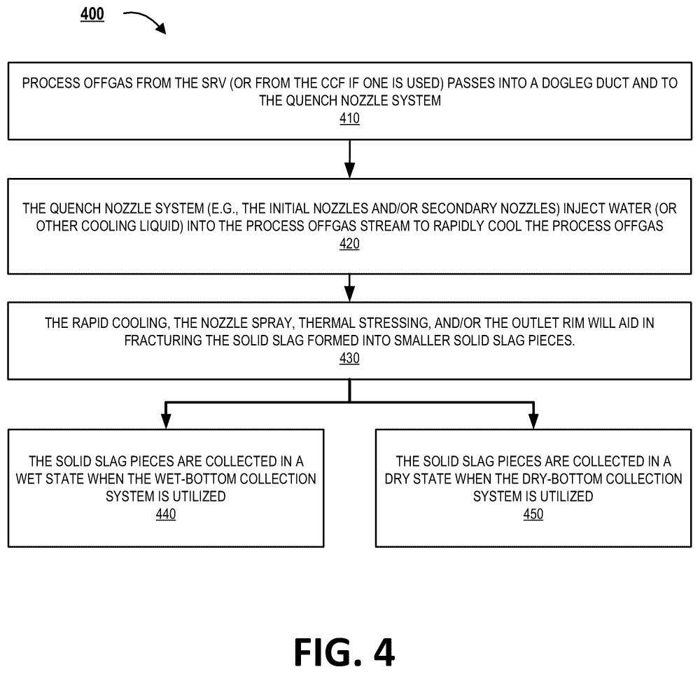

Referring to the figures, FIG. 1 illustrates a direct smelting process with an SRV 101, a CCF 102 and a fast quench system 200. Moreover, FIG. 4 illustrates a high level process flow for the direct smelting and fast quench process described herein. As illustrated in FIG. 1 and block 410 of FIG. 4, hot CCF process offgas (or SRV 101 process offgas in a HIsmelt system) passes into an offgas duct, in particular, a dogleg duct 104. In some embodiments, supplementary oxygen 103 is injected as shown to complete combustion of residual carbon monoxide and hydrogen in the process offgas. Gas temperature at the outlet of the dogleg duct 104 is above 1400° C. (2552° F.), typically 1600-2000° C. (2912-3632° F.), and the dogleg duct 104 itself may be constructed from steam tubes which maintain metal wall metal temperatures in the range 150-300° C. (302-572° F.). The inner surfaces of the walls of the dogleg duct 104 are equipped with slag studs (or similar, or other mechanical devices) to ensure the presence of frozen slag layers adjacent to the walls with the metal tubes. Frozen FeO-rich slag layers of about 20-30 mm (0.787-1.181 inches) in thickness are maintained on the walls and, on the inner surfaces of the frozen slag layers that are in contact with hot process offgas, slag is hot and substantially liquid.

The offgas duct 104 (e.g., dogleg duct) may impose deliberate flow direction changes at the end of the dogleg duct 104 before it connects with the quench nozzle system 106. For example, the end of the dogleg 104 may change the direction of the process offgas from near horizonal to vertical, back to near-horizontal, and from near-horizontal back to vertical (e.g., in the downleg of the dogleg duct before the process offgas is delivered to the quench nozzle system 106. For example, as illustrated in FIG. 1, the end of the dogleg 104 may include an inverted-U shaped dogleg end 120, having an upleg duct portion 122, a top duct portion 124, and a downleg duct portion 126. This dogleg end 120 is different than the hood previously described herein, in that the legs 122, 124, 126 are much shorter than the portions in a hood (e.g., 1, 2, 3, 4, 5, 7, 8, 9, 10, or the like meters long), and include the mechanical devices (e.g., studs, or the like) that promote slag adhesion within the dogleg end 120. For example, the mechanical devices (e.g., the studs, or the like) may be included up until downleg duct 126 reaches the nozzle system 106.

This configuration may be used to trap as much entrained liquid from the CCF 102 (or the SRV 101 in the HIsmelt process) as possible on the walls. Moreover, since the innermost slag layer within the dogleg duct 104 is substantially liquid, it can flow back from the upleg portion 122 and/or top portion 124 (countercurrent to the main offgas stream) under gravity into the SRV 101 (e.g., through the CCF 102 in the HIsarna process).

Pressure relief valves 105 are located at the top of the final bend in the dogleg (e.g., in the top portion 124 of the dogleg end 120, or the like). The pressure relief valves 105 may be required to ensure safety in the event of a slag eruption or other sudden pressure increase in the system.

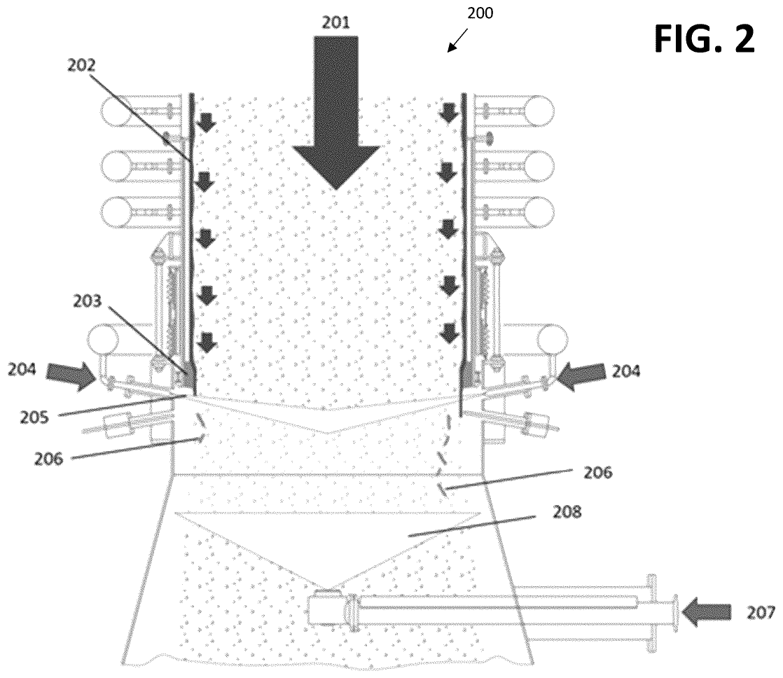

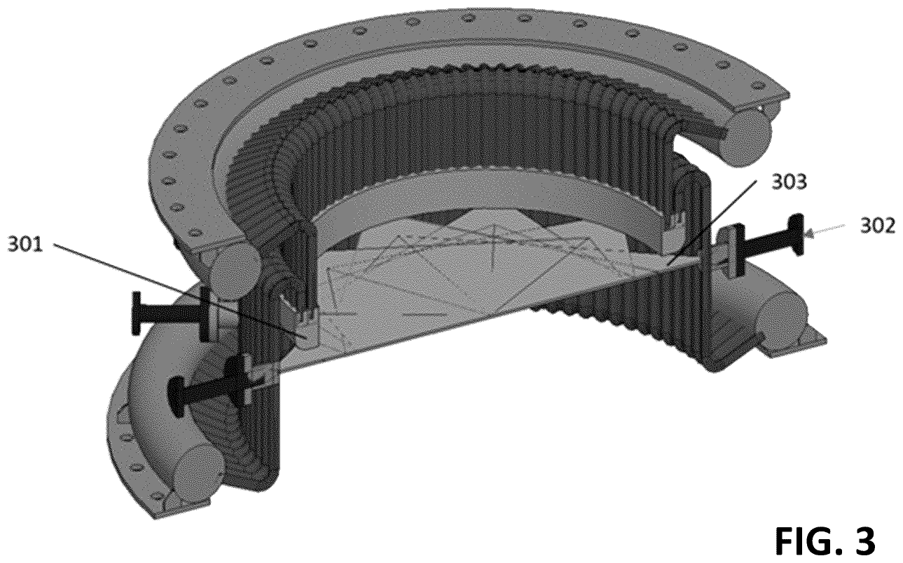

The final bend in duct 104 (e.g., regardless of whether or not the inverted-U shaped dogleg end 120 is utilized) directs the process offgas downwards into the nozzle system 106 of the fast quench system 200. As illustrated in block 420 of FIG. 4, water is injected into the process offgas stream via the fast quench nozzle system 106, which will be described in more detail with reference to FIGS. 2 and 3. The process objective is to cool the hot process offgas from 1400° C. (2552° F.) or higher to 600° C. (1112° F.) or lower in an average gas particle time-of-flight of less than about 1 second, thereby freezing, stressing and breaking initially molten slag flowing downwards along the hot walls of the dogleg outlet. Initial water injection via initial spray nozzles of the spray system 106 occurs a short distance below the bottom of the dogleg outlet, and further secondary water spray nozzles 107 may be used below the initial spray nozzles.

As illustrated by block 430 of FIG. 4 and as will be described in further detail with respect to FIGS. 2 and 3, the rapid cooling, the nozzle spray, thermal stressing, and/or the outlet rim 203 of the fast quench system 200 will aid in solidifying molten slag in the process offgas and/or on the walls of the offgas duct into fractured solid slag pieces.

Hot process offgas, dust and slag will mix rapidly with injected water spray droplets in the quench chamber 108. Water will vaporize and the process offgas will cool to a temperature below 600° C. (1112° F.). Depending on how the system is configured, the final gas outlet temperature could be 200-300° C. (392-572° F.) in the dry bottom option, or 110-120° C. (230-248° F.) in the wet bottom version.

As illustrated in block 440 of FIG. 4, if the wet-bottom system is used, as previously described herein a generous excess of water is used, and the final gas mixture will approach water saturation. Liquid water will be present at collection sluice 109, from where it will entrain broken solid slag pieces and run out to an appropriate solid settling and water handling system.

As illustrated in block 450 of FIG. 4, if the dry-bottom version is used, solids will be collected in a dry state at 200-300° C. (392-572° F.) and removed from a collection hopper via lock-vessel system 110. As previously discussed, in the dry-bottom version, careful attention to detail will be needed to avoid water condensation. In particular, heat tracing may be required in this part of the system to maintain suitably high internal surface temperatures (greater than about 150° C.; 302° F.) at all times.

Warm, dusty process offgas from the quench chamber 108 passes to a wet scrubber 112. A pressure relief valve 111 may be located at the top of the moist gas bend as indicated, to provide an additional safety outlet in the event of a pressure increase or SRV slag foaming event.

Warm, dusty gas is conditioned via additional water sprays in scrubber 112 before passing through cone valve 113 where fine water droplets are created (for efficient dust capture and removal). Cone valve pressure drop is typically 0.2-0.5 bar and cone valve position is used to regulate pressure in the SRV (which typically operates around 0.5-0.8 bar gauge). From this point cleaned gas 114 passes to further gas handing operations downstream.

FIG. 2 shows further details of the quench system 200 including the fast quench nozzle system 106, described and illustrated with respect to FIG. 1. Hot downflowing process offgas 201, at a temperature of typically 1600-2000° C. (2912-3632° F.), contains droplets of molten slag and a downflowing liquid slag wall film 202 (otherwise described as the “pipe” of solid slag). The wall of the dogleg outlet duct 104 terminates in a smooth water-cooled copper rim 203. Molten slag flows downwards over the surface of the cold copper rim 203, but adhesion between the solid slag part of the freeze-layer and the water-cooled copper rim 203 is weak to non-existent. This deprives the “pipe” of solid slag of some mechanical strength and makes it more susceptible to breaking up into pieces when quench cooled by the nozzle system 106.

Water 204 (or other cooling liquid) is injected via spray nozzles of the nozzle system 106 to produce a spray plume 205. This spray plume provides rapid slag solidification and cooling in conjunction with thermal stressing which causes the solid slag to break into slag pieces 206 small enough (typically <100 mm diameter; 3.94 inches diameter) that then can be managed and removed in suitable downstream equipment, as previously described herein.

The amount of water 204 added from the initial spray nozzles of the nozzle system 106 may be less than the total needed to achieve the necessary final temperature. As such, additional water 207 may be added in one or more secondary downstream nozzles 107 to produce one or more spray plumes 208. It should be understood that the majority of the cooling of the process offgas in the quench system 200 occurs through the quench nozzle system 106. The cooling provided from duct cooling (e.g., steam tubes, or the like) may provide a minority of the cooling of the process offgas, or may be insignificant.

FIG. 3 shows a 3-dimensional view of the fast quench system 200 including the nozzle system 106. The dogleg outlet terminates at the water-cooled copper rim 301 (illustrated as 203 in FIG. 2). Spray water 302, illustrated in FIG. 3, produces relatively flat, radially (inwardly) directed spray plume 303. Water injection may be augmented by gas injection to produce an appropriate balance between inward momentum, droplet size and gas entrainment.

It should be understood that the spray pattern of the nozzles of the nozzle system 106 illustrated in FIG. 2 is generally inward and directed at a downward angle in the same direction of the flow of the process offgas. However, in other embodiments, the spray pattern of the nozzles of the nozzle system 106 illustrated in FIG. 3 is generally inward and horizonal with respect to the flow of the process offgas. Moreover, the radial spray patten of the nozzles could be directly at least partially upwards with respect to the flow of the process offgas at the dogleg duct outlet, however, this direction may be detrimental to solid slag formation.

It should be further understood, that in some embodiments in addition to, or in lieu of, the rim 203 described herein that may be utilized to aid in breaking the solid slag “pipe” into solid pieces, other means of fracturing may be utilized, such as, mechanical actuation of a member (e.g., rod, block, portions of the rim, or the like) that can be actuated into and/or out of the duct outlet and/or quench chamber 108 in order to aid in fracturing the solid slag into solid slag pieces.

As previously described, by utilizing the invention described herein, the ability for heat recovery from the process offgas may be no longer possible. However, in some embodiments of the invention heat recovery may still be possible by using a configuration that includes the dry-bottom embodiment and operating the system such that temperatures at the outlet of chamber 108 are deliberately maintained at the higher end of the temperature range (e.g., 500-600° C., or 932-1112° F.). It may be that, under such conditions, tube fouling is slow and/or manageable enough in a practical sense and heat recovery again becomes possible. If so, installation of heat recovery tubes for steam generation between chamber 108 and wet scrubber 112 could be regarded as a legitimate variation, which is fully consistent with the scope of this invention.

To supplement the present disclosure, this application further incorporates entirely by reference the following references:
1. U.S. Pat. No. 6,989,042 “Direct Smelting Process and Apparatus”, Priority 17 Apr. 2000
2. U.S. Pat. No. 8,221,675 “Direct Smelting Vessel and Cooler Therefor”, Priority 18 May 2006
3. U.S. Pat. No. 9,175,907 “Direct Smelting Process and Apparatus”, Priority 9 Feb. 2010
4. Australian Patent 2011301784 (WO2012/034184) “Direct Smelting Process”, Priority 15 Sep. 2011
5. U.S. Pat. No. 9,359,656 “Direct Smelting Process”, Priority 9 Feb. 2012
6. PCT/AU2012/000293 (WO2012/126055) “Direct Smelting Process for High Sulphur Feed”, Priority 21 Mar. 2012
7. PCT/AU2012/001486 (WO2013/082658) “Starting a Smelting Process”, Priority 6 Dec. 2011
8. PCT/AU2012/001481 (WO2013/082653) “Starting a Smelting Process”, Priority 6 Dec. 2011
9. PCT/AU2012/001487 (WO2013/082659) “Starting a Smelting Process”, Priority 6 Dec. 2011
10. CT/AU2014/001098 (WO2015/081376) “Smelting Process and Apparatus”, Priority 4 Dec. 2014
11. PCT/AU2014/001146 (WO2015/089563) “Smelting Process and Apparatus”, Priority 19 Dec. 2014

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and should not be interpreted in an idealized or overly formal sense unless expressly so defined herein. Certain terminology is used herein for convenience only and is not to be taken as a limitation on the invention. For example, words such as “upper,” “lower,” “left,” “right,” “horizontal,” “vertical,” “upward,” and “downward” merely describe the configuration shown in the figures. The referenced components may be oriented in an orientation other than that shown in the drawings and the terminology, therefore, should be understood as encompassing such variations unless specified otherwise.

It will be understood that when an element is referred to as being “connected,” “coupled,” or “operatively coupled” to another element, the elements can be formed integrally with each other, or may be formed separately and put together. Furthermore, “connected,” “coupled,” or “operatively coupled” to can mean the element is directly connected, coupled, or operatively coupled to the other element, or intervening elements may be present between the elements. Furthermore, “connected,” “coupled,” or operatively coupled” may mean that the elements are detachable from each other, or that they are permanently coupled together.

Specific embodiments of the invention are described herein. Many modifications and other embodiments of the invention set forth herein will come to mind to one skilled in the art to which the invention pertains, having the benefit of the teachings presented in the foregoing descriptions and the associated drawings. Therefore, it is to be understood that the invention is not to be limited to the specific embodiments disclosed and that modifications and other embodiments and combinations of embodiments are intended to be included within the scope of the appended claims. Although specific terms are employed herein. they are used in a generic and descriptive sense only and not for purposes of limitation.

1. A direct smelting method for production of molten metal and slag within a direct smelting system, wherein the direct smelting system comprises:
(i) a smelt reduction vessel (SRV) containing a bath of the molten metal and the slag, wherein carbonaceous material is injected and metalliferous ore is injected or fed by gravity into the slag from above, wherein smelting of the metalliferous ore takes place to produce carbon-containing molten metal and molten slag and wherein oxygen-containing gas is injected into a topspace of the SRV to partially combust bath-derived gas and provide SRV process heat,
(ii) a quench system operatively coupled to the SRV, wherein the quench system comprises a dogleg duct and a quench nozzle system operatively coupled to the dogleg duct,
wherein the direct smelting method comprises:
receiving process offgas in the dogleg duct from the SRV, wherein the process offgas contains entrained molten slag;
directing the process offgas from the dogleg duct to the quench nozzle system;
rapidly cooling the process offgas using the quench nozzle system to a temperature that is less than or equal to 600° C. to form solid slag; and
fracturing the solid slag into solid slag pieces for removal.

2. The method of claim 1, wherein the direct smelting system further comprises a cyclone converter furnace (CCF) connected to the SRV, wherein the CCF receives the process offgas from the SRV, wherein the metalliferous ore, a proportion of the oxygen-containing gas, and flux material are injected into the CCF, and wherein the metalliferous ore is substantially melted and partly pre-reduced before entering the SRV, and
wherein receiving the process offgas in the dogleg duct comprises receiving the process offgas from the CCF.

3. The method of claim 1, wherein the process offgas within the dogleg duct is maintained at a gas temperature that is greater than or equal to 1400° C. (2552° F.) before the rapid cooling by the quench nozzle system.

4. The method of claim 1, wherein an average process offgas particle time-of-flight in the quench nozzle system is less than or equal to 1 second.

5. The method of claim 1, wherein the quench nozzle system injects 0.8-2.0 tonnes of water per 1000 Nm³/h of the process offgas, and wherein a final gas temperature after water vaporization is greater than or equal to 150° C. (302° F.) and less than or equal to 600° C. (1112° F).

6. The method of claim 5, wherein the quench nozzle system preferably injects 1.0-1.5 tonnes of water per 1000 Nm³/h of the process offgas, and wherein the final gas temperature after water vaporization is preferably in a temperature range 200-300° C. (392-572° F.), inclusive.

7. The method of claim 5, wherein the solid slag pieces are removed from a collection vessel at a bottom of a quench chamber in a dry state.

8. The method of claim 1, wherein the quench nozzle system injects 2-6 tonnes of water per 1000 Nm³/h of the process offgas, and wherein a final gas temperature is approximately equivalent to a local water saturation temperature at prevailing process pressure.

9. The method of claim 8, wherein the quench nozzle system preferably injects 3-5 tonnes of water per 1000 Nm³/h of the process offgas.

10. The method of claim 8, wherein liquid water is present at a bottom of a quench chamber and the solid slag pieces are removed from a collection vessel of the quench chamber in a wet state.

11. The method of claim 1, wherein the quench system further comprises an outlet rim upstream from the quench nozzle system, wherein the outlet rim aids in fracturing the solid slag into the solid slag pieces.

12. A direct smelting system for production of molten metal and slag, the direct smelting system comprising:
(i) a smelt reduction vessel (SRV), wherein the SRV is configured to contain a bath of the molten metal and the slag, receive carbonaceous material injected and metalliferous ore injected or fed by gravity into the slag from above, smelt the metalliferous ore in the bath to produce carbon-containing molten metal and molten slag, and receive oxygen-containing gas injected into a topspace to partially combust bath-derived gas and provide heat to the SRV; and
(ii) a quench system operatively coupled to the SRV, wherein the quench system comprises a dogleg duct and a quench nozzle system operatively coupled to the dogleg duct, wherein process offgas from the SRV containing entrained molten slag passes through the dogleg duct to the quench nozzle system, and wherein the process offgas is rapidly cooled by the quench nozzle system to a temperature that is less than or equal to 600° C. (1112° F.) to form solid slag that fractures into solid slag pieces for removal.

13. The system of claim 12, wherein the direct smelting system further comprises a cyclone converter furnace (CCF) connected to the SRV, wherein the CCF receives the process offgas from the SRV, wherein the metalliferous ore, a portion of the oxygen-containing gas, and flux material are injected into the CCF, and wherein the metalliferous ore is substantially melted and partly pre-reduced before entering the SRV, and
wherein the dogleg duct receives the process offgas from the CCF.

14. The system of claim 12, wherein the process offgas within the dogleg duct is maintained at a gas temperature that is greater than or equal to 1400° C. (2552° F.) before the rapid cooling by the quench nozzle system.

15. The system of claim 12, wherein an average process gas particle time-of-flight in the quench nozzle system is less than or equal to 1 second.

16. The system of claim 12, wherein a majority of the cooling of the process gas in the quench system occurs through the quench nozzle system with a minority of the cooling occurring through duct cooling.

17. The system of claim 12, wherein the quench nozzle system injects 0.8-2.0 tonnes of water per 1000 Nm3/h of the process offgas, and wherein a final gas temperature after water vaporization is greater than or equal to 150° C. (302° F.) and less than or equal to 600° C. (1112932° F.).

18. The system of claim 17, wherein the solid slag pieces are removed from a collection vessel at a bottom of a quench chamber in a dry state.

19. The system of claim 12, wherein the quench nozzle system injects 2-6 tonnes of water per 1000 Nm³/h of the process offgas, and wherein a final gas temperature is approximately equivalent to a local water saturation temperature at prevailing process pressure.

20. The system of claim 19, wherein liquid water is present at a bottom of a quench chamber and the solid slag pieces are removed from a collection vessel of the quench chamber in a wet state.

21. The system of claim 12, wherein the quench system further comprises an outlet rim upstream from the quench nozzle system, wherein the outlet rim aids in fracturing the solid slag into solid slag pieces.

22. A method of forming pig iron using a quench system operatively coupled to a smelt reduction vessel (SRV), wherein the quench system comprises a dogleg duct and a quench nozzle system operatively coupled to the dogleg duct, the method comprising:
forming molten metal in the SRV;
receiving process offgas in the dogleg duct from the SRV, wherein the process offgas contains entrained molten slag;
directing the process offgas from the dogleg duct to the quench nozzle system;
rapidly cooling the process offgas using the quench nozzle system to a temperature that is less than or equal to 600° C. to form solid slag;
fracturing the solid slag into solid slag pieces for removal;
removing the molten metal from the SRV; and
forming pig iron from the molten metal.

23. A quench system for use with a smelt reduction vessel (SRV), for production of molten metal and slag, the quench system comprising:
a dogleg duct; and
a quench nozzle system operatively coupled to the dogleg duct;
wherein process offgas from the SRV containing entrained molten slag passes through the dogleg duct to the quench nozzle system, and wherein the process offgas is rapidly cooled by the quench nozzle system to a temperature that is less than or equal to 600° C. (1112° F.) to form solid slag that fractures into solid slag pieces for removal.
